(19) United States
(12) Patent Application Publication
(10) Pub. No.: US 2026/0336477 A1
(43) Pub. Date: Oct. 29, 2026

(54) VEHICLE SEAT

(71) Applicants: TS TECH CO., LTD., Asaka-shi (JP); HONDA MOTOR CO., LTD., Tokyo (JP)

(72) Inventors: Sachio KOBAYASHI, Shioya-gun (JP); Hidetsune NONAKA, Shioya-gun (JP); Manabu MATSUMOTO, Tokyo (JP); Koyo YASUMOTO, Tokyo (JP)

(21) Appl. No.: 19/431,088

(22) Filed: Dec. 23, 2025

Related U.S. Application Data
(60) Provisional application No. 63/738,904, filed on Dec. 26, 2024.

(51) Int. Cl. B60N 2/015; B60N 2/06

(52) U.S. Cl. CPC B60N 2/015; B60N 2/06

(57) ABSTRACT

A vehicle seat includes, a first fixer that is configured to fix a slide rail that supports a seat main body to a vehicle body floor; and a second fixer that is mounted to the first fixer and that is configured to fix a predetermined member provided on the seat main body. The second fixer is provided with a regulator that regulates a movement of the second fixer relative to the first fixer until the second fixer is mounted and fixed to the first fixer.

### CROSS-REFERENCE TO RELATED APPLICATION

This application is based upon and claims the benefit of priority from the provisional US Patent Application No. 63/738,904, filed on Dec. 26, 2024, the entire contents of which are incorporated herein by reference.

### BACKGROUND OF THE INVENTION

### Technical Field

The present disclosure relates to a vehicle seat.

### DESCRIPTION OF RELATED ART

Conventionally, a seat for a vehicle is known in which a heater as a fastening releasing means that releases fastening by the fastening means fastening the vehicle seat to the vehicle body and that frees the fixing between the vehicle seat and the vehicle body is held by a fixing bracket fixed to a lower rail of the vehicle seat. In this state, the vehicle seat is fixed with a bolt to a foot bracket of the vehicle. (See, for example, FIGS. 10 and 11 of Japanese Patent Application Publication No. 2008-207628).

However, in the case of the vehicle seat of the above-mentioned JP 2008-207628, when fixing the heater to the foot bracket via the fixing bracket, the relative positions of the fixing bracket and the foot bracket may be misaligned, which makes it difficult to perform the work of fixing the heater, which is a predetermined component, to the seat.

### SUMMARY OF THE INVENTION

The purpose of the present disclosure is to provide a vehicle seat having a structure that facilitates fixing a predetermined member to the seat.

In order to solve the above problems, according to one aspect of the present disclosure, a vehicle seat includes,
a first fixer that is configured to fix a slide rail that supports a seat main body to a vehicle body floor; and
a second fixer that is mounted to the first fixer and that is configured to fix a predetermined member provided on the seat main body,
wherein the second fixer is provided with a regulator that regulates a movement of the second fixer relative to the first fixer until the second fixer is mounted and fixed to the first fixer.

### BRIEF DESCRIPTION OF DRAWINGS

The accompanying drawings are not intended as a definition of the limits of the invention but illustrate embodiments of the invention, and together with the general description given above and the detailed description of the embodiments given below, serve to explain the principles of the invention, wherein:

FIG. 1 is a perspective view showing a vehicle seat according to the present embodiment;

FIG. 2 is a perspective view showing a cushion frame of the vehicle seat according to the present embodiment;

FIG. 3 is an enlarged perspective view of a location where a cover member is provided in the vehicle seat;

FIG. 4 is an enlarged top view of the location where the cover member is provided in the vehicle seat;

FIG. 5 is a perspective view showing a state in which a foot bracket and a fixing bracket are fixed in the vehicle seat;

FIG. 6 is a front view showing the state in which the foot bracket and the fixing bracket are fixed in the vehicle seat;

FIG. 7 is a rear view showing the state in which the foot bracket and the fixing bracket are fixed in the vehicle seat;

FIG. 8 is a top view showing the state in which the foot bracket and the fixing bracket are fixed in the vehicle seat;

FIG. 9 is a bottom view showing the state in which the foot bracket and the fixing bracket are fixed in the vehicle seat;

FIG. 10 is a perspective view showing a location in which the foot bracket and the fixing bracket are fixed in the vehicle seat, and a state in which a harness and a connector are not fixed to the fixing bracket is shown;

FIG. 11 is a top view showing the location in which the foot bracket and the fixing bracket are fixed in the vehicle seat, and a state in which the harness and the connector are not fixed to the fixing bracket is shown;

FIG. 12 is a bottom view showing the location in which the foot bracket and the fixing bracket are fixed in the vehicle seat, and a state in which the harness and the connector are not fixed to the fixing bracket is shown;

FIG. 13 is a bottom view showing a state in which a cover member of the vehicle seat is latched to the latched member;

FIG. 14 is a perspective view showing from a rear side the location in which the foot bracket and the fixing bracket are fixed;

FIG. 15 is an enlarged view showing a location in which a hook section of the fixing bracket is engaged in a hole section in the foot bracket;

FIG. 16 is a cross-sectional view at a line XVI-XVI shown in FIG. 14;

FIG. 17 is an explanatory diagram regarding a procedure for fixing the harness and the connector to the foot bracket via the fixing bracket;

FIG. 18 is an explanatory diagram regarding the procedure for fixing the harness and the connector to the foot bracket via the fixing bracket;

FIG. 19 is an explanatory diagram regarding a procedure for fixing the harness and the connector to the foot bracket

via the fixing bracket; and

FIG. 20 is an explanatory diagram regarding a procedure for fixing the harness and the connector to the foot bracket via the fixing bracket.

### DETAILED DESCRIPTION

Hereinafter, one or more embodiments of the present disclosure will be described with reference to the drawings. However, the scope of the present disclosure is not limited to the disclosed embodiments.

The following is a detailed description of an embodiment of the vehicle seat according to the present disclosure with reference to the drawings. However, the embodiments described below are subject to various technically preferred limitations for implementing the present disclosure, but the scope of the present disclosure is not limited to the following embodiments and illustrated examples.

In the following, a front-rear direction, a left-right direction, and an up-down direction are defined and explained. Here, a backrest side of a seat is "rear," the opposite side is "front," a left hand side when seated in the seat and looking forward is "left," a right hand side when seated in the seat and looking forward is "right", and the up-down direction is equivalent to a vertical direction. In other words, a width direction of the seat corresponds to the left-right direction.

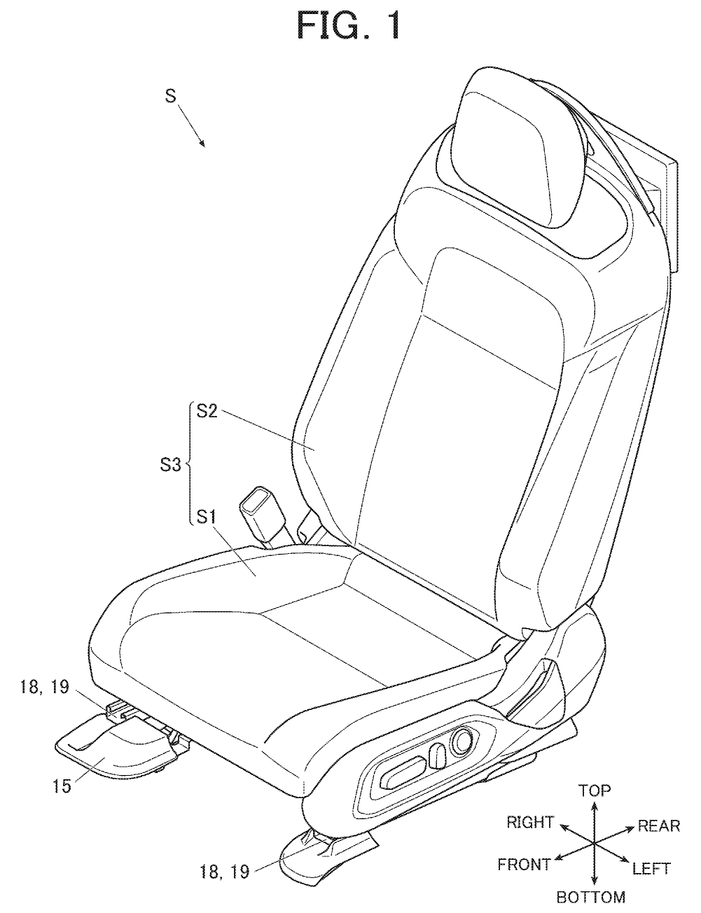

As shown in FIG. 1, for example, a vehicle seat S according to the present embodiment includes a seat main body S3 including a seat cushion S1 as a seating portion, and a seatback S2 as a backrest.

The seat main body S3 is supported by a slide rail 19 described below, and is fixed to a vehicle floor via the slide rail 19, etc.

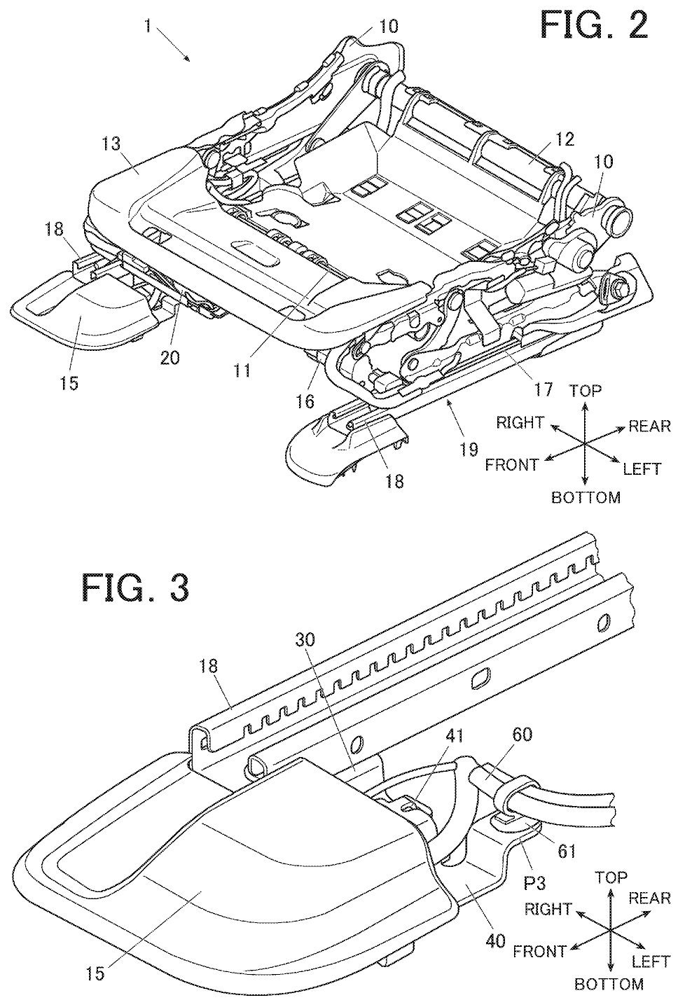

A cushion frame 1 as shown in FIG. 2 is provided inside the seat cushion S1, for example.

This cushion frame 1 is covered with a pad made of urethane foam or the like, which is then covered with a surface material made of fabric, leather, or the like to form the seat cushion S1.

Although illustration is omitted, the seatback S2 is similarly constructed by covering the back frame as a framework with the pad and the surface material.

The cushion frame 1 includes, for example, as shown in FIG. 2, a left and right pair of side frames 10, a first connecting frame 11 that connects one end of the left and right pair of side frames, and a second connecting frame 12 that connects the other end of the left and right pair of side frames.

The cushion frame 1 further includes a pan frame 13 positioned to the front side than the first connecting frame 11.

The left and right pair of side frames 10 here are asymmetrical (left-right) in shape.

The side frames 10 are frames made of metal plates and are arranged as a pair, spaced apart to left and right.

The first connecting frame 11 and the second connecting frame 12 are positioned spaced apart to the front and rear from each other.

The first connecting frame 11 is a so-called front frame made of a metal pipe with a circular cross section, and connects front parts of a pair of side frames 10.

The second connecting frame 12 is a so-called rear frame made of the metal pipe with the circular cross section, and connects rear parts of the pair of side frames 10.

The pan frame 13 is a frame made of the metal plate and connects the front parts of the pair of side frames 10 to each other at a position to the front side than the first connecting frame 11.

The cushion frame 1 is installed on a floor of a vehicle via the slide rail 19, etc.

The slide rail 19 includes a pair of lower rails 18 that extend in the front-rear direction and that are positioned spaced apart to the left and right, a pair of upper rails 17 that are provided engaged with each lower rail 18 so a to be able to slide to the front and rear, and the like.

The lower rail 18 is fixed to the vehicle floor (not shown), by a foot bracket 30 described below, and the upper rail 17, which is slidably provided on the lower rail 18, is fixed to the cushion frame 1.

In other words, this vehicle seat S is installed on the floor of the vehicle in such a way that it can slide to the front and rear.

A cover member 15 (cover) is positioned on a leading end side of the lower rail 18, and in FIGS. 1-4 , a large part of the foot bracket 30 fixing the lower rail 18 to the vehicle floor is covered by the cover member 15.

The slide rail 19 according to the present embodiment is an electrically driven slide mechanism as follows. By driving a motor 16 located on the upper rail 17 side, the upper rail 17 moves along the lower rail 18, and with this, the seat slides to the front and the rear.

For example, the motor 16 located in the cushion frame 1 on the upper rail 17 side rotates a pinion gear that teeth a rack provided along an extending direction of the lower rail 18, causing the upper rail 17 to move along the lower rail 18. The configuration and operation of the electrically operated slide rail 19 is the same as those that are previously known, so it is not described in detail here.

The vehicle seat S is also provided with an electrical component 20, and such electrical component 20 is installed in the cushion frame 1.

The electrical component 20 installed in the cushion frame 1 is, for example, a blower for taking air into the seat cushion S1.

The predetermined members that are provided in the seat main body S3 and that are connected to the electrical component 20 are the harness 60 and connector 70, which are described below.

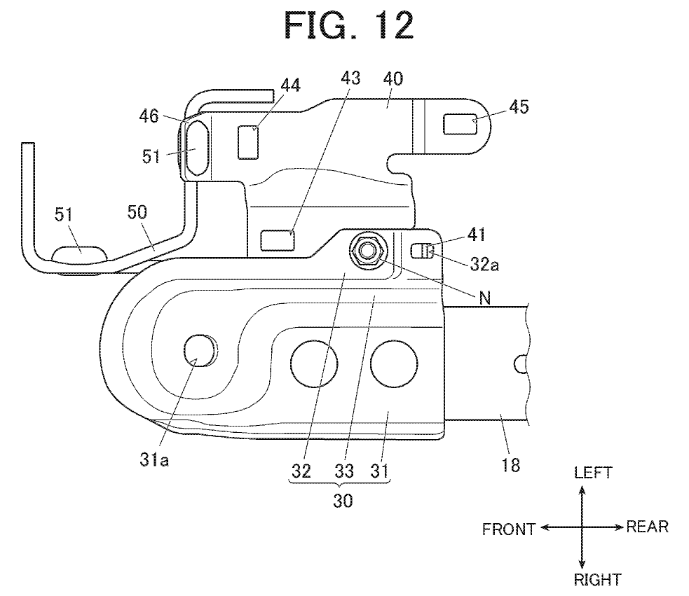

The vehicle seat S according to the present embodiment includes, for example, as shown in FIGS. 3-20 , the foot bracket 30 which is a first fixing member (first fixer) for fixing a slide rail 19 (lower rail 18) that supports the seat main body S3 to a vehicle body floor (not shown), and a fixing bracket 40 which is a second fixing member (second fixer) for fixing a predetermined member provided in the seat main body S3.

The fixing bracket 40 for fixing the predetermined member is attached to foot bracket 30 and fixed.

The fixing bracket 40 is provided with a regulating section (regulator) (hook section 41 (hook) described below) that regulates the movement of the fixing bracket 40 relative to the foot bracket 30 until the fixing bracket 40 is attached and fixed to the foot bracket 30.

The fixing bracket 40 is also a member that functions to fix the predetermined member to the foot bracket 30.

The foot bracket 30 is, for example, a member formed by stamping sheet metal, and includes a bracket main body section 31 for fixing the slide rail 19 (lower rail 18) to the vehicle body floor (not shown), and a flange section 32 for fixing the fixing bracket 40 to the foot bracket 30.

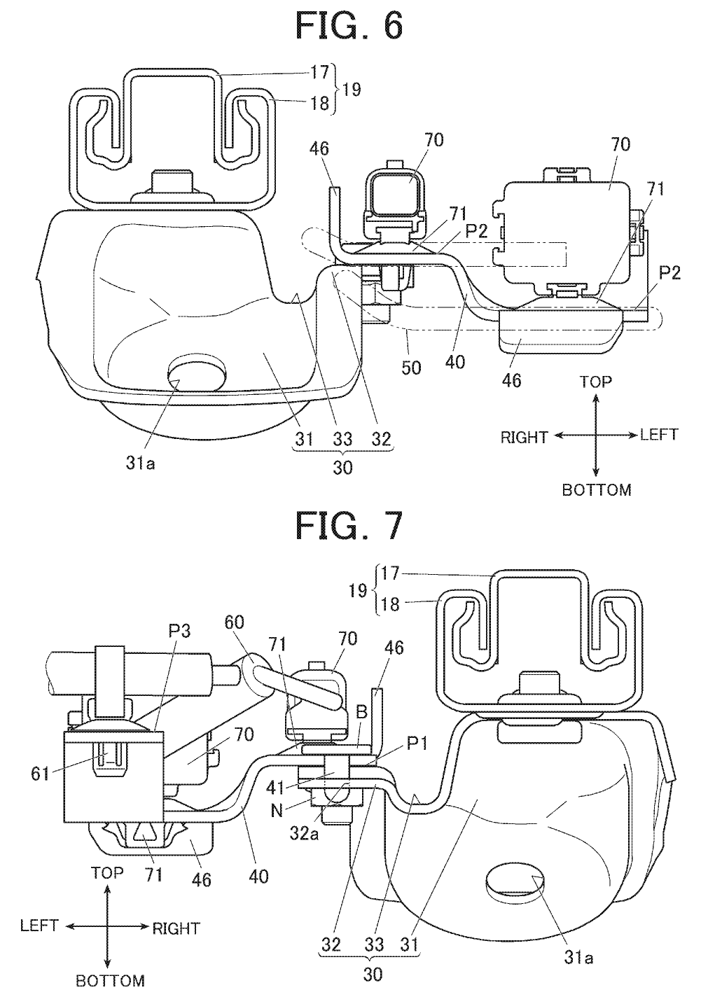

Between the bracket main body section 31 and the flange section 32, a reinforcing section (reinforcer) 33 is provided to reinforce the flange section 32 (see FIGS. 6,7 and 14, ).

The bracket main body section 31 is provided with a bolt hole 31a through which the fixing member that fixes the foot bracket 30 to the vehicle body floor (not shown), is inserted.

The flange section 32 is provided with a hole section 32a (hole) where the hook section 41 of the fixing bracket 40 is engaged and a bolt hole 32b (see FIG. 16) through which a bolt B that fixes the fixing bracket 40 to the foot bracket 30 is inserted.

The reinforcing section 33 is, for example, a bent portion formed by beading in the stamping process.

By providing this reinforcing section 33 near the flange section 32, a rigidity of the flange section 32 can be increased and the strength of the foot bracket 30 to which the fixing bracket 40 is fixed can be increased.

The fixing bracket 40 is a member formed by pressing the sheet metal, for example.

The fixing bracket 40 is provided with the hook section 41 as a regulating section that is engaged in the hole section 32a of the foot bracket 30 (flange section 32) and a bolt hole 42 (see FIG. 16) through which the bolt B that fixes the fixing bracket 40 to the foot bracket 30 is inserted. The hook section 41 is formed to present a hook shape.

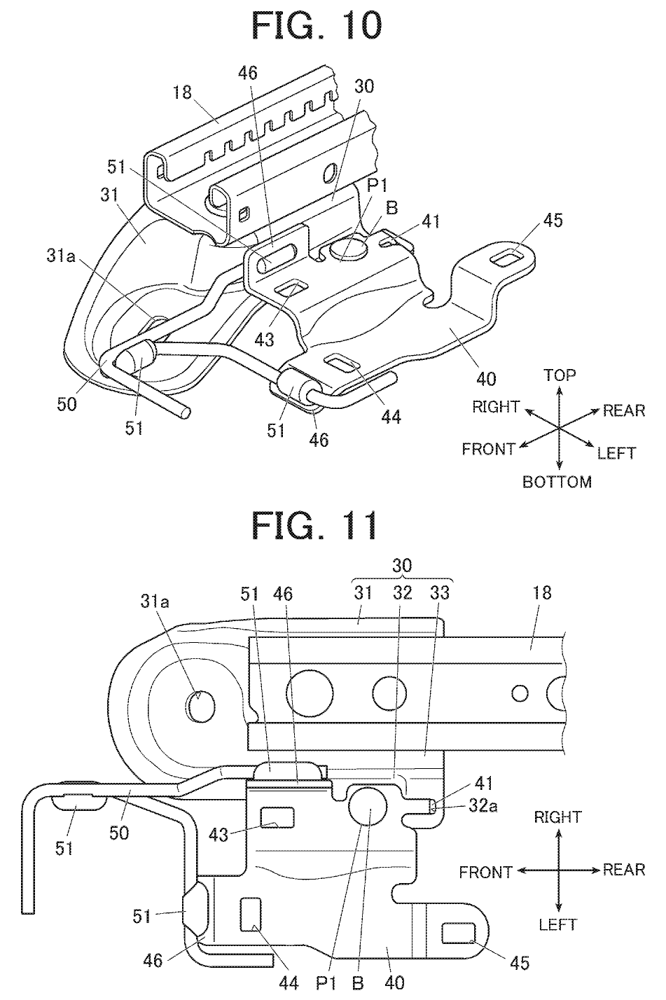

The fixing bracket 40 is provided with three mounting holes 43, 44, and 45 (see FIGS. 10-12 ) for attaching and fixing the predetermined member to the fixing bracket 40.

The predetermined members according to the present embodiment are the harness 60 and the connector 70, which are connected to the electrical component 20 and installed in the seat main body S3.

There are steps in the fixing bracket 40 at locations where the mounting hole 43, the mounting hole 44, and the mounting hole 45 are provided, respectively.

Here, the location where the mounting hole 43 is provided is a middle step, the location where the mounting hole 44 is provided is a bottom step, and the location where the mounting hole 45 is provided is a top step.

As described above, by adding the step to the location of the fixing bracket 40 where the mounting holes (43, 44, 45) are provided, even when the sizes of the three predetermined members mounted to the three mounting holes (43, 44, 45) respectively are different, it is possible to suppress the predetermined members overhanging in a height direction (vertical direction).

Specifically, as described below, the relatively small connector 70 is mounted to the mounting hole 43 in the middle step, the relatively large connector 70 is mounted to the mounting hole 44 in the bottom step, and the flat harness 60 is mounted to the mounting hole 45 in the top step. Consequently, the height positions of the relatively small connector 70, the relatively large connector 70, and the flat harness 60 can be aligned at approximately the same position, the thickness of the assembly consisting of these members mounted to the fixing bracket 40 can be suppressed and the assembly becoming larger in the height direction can be suppressed (see FIGS. 6 and 7 ).

By suppressing the thickness of the assembly consisting of the connector 70 and the harness 60 mounted to the fixing bracket 40, the assembly can be installed in a narrow region around the foot bracket 30.

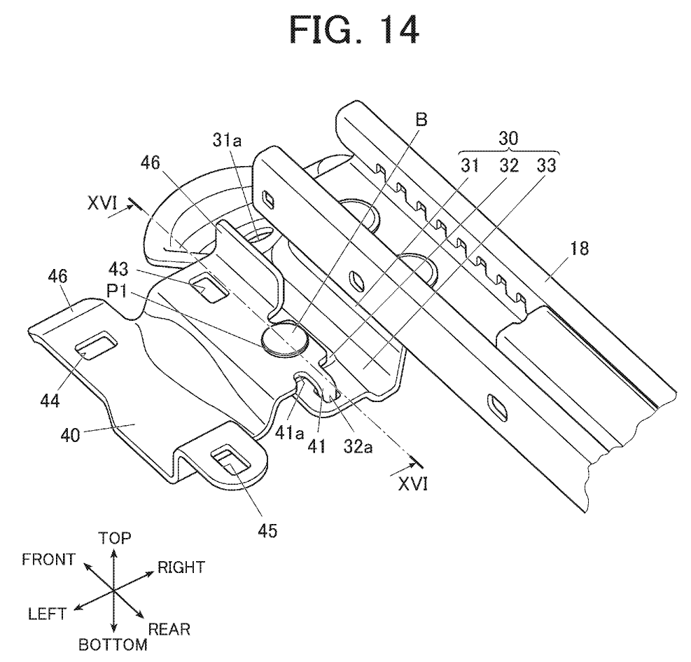

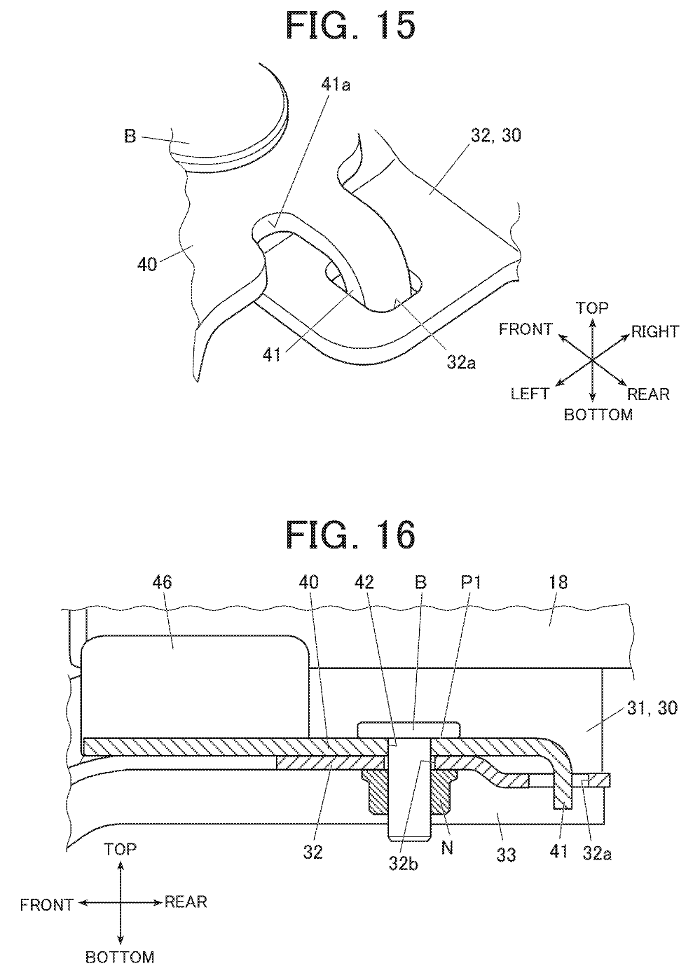

The fixing bracket 40 is provided with a recess section 41a in a cutout shape at a position adjacent to a base of the hook section 41 (see FIGS. 14 and 15).

By providing the recess section 41a next to the base of the hook section 41, the base of the hook section 41 is less rigid and easier to bend, making it easier to form the hook section 41.

Here, the recess section 41a is provided on the left side of the base of the hook section 41 in order to align the left and right position of the base of the hook section 41 in the front-rear direction.

With this, the force of the bending process acts evenly on the hook section 41 portion, allowing the hook section 41 to be formed suitably.

The fixing bracket 40 is provided with fixing end pieces 46 (see FIGS. 10-12) in 2 locations. The fixing end piece 46 is for fixing a latched member 50 to which the cover member 15 is latched.

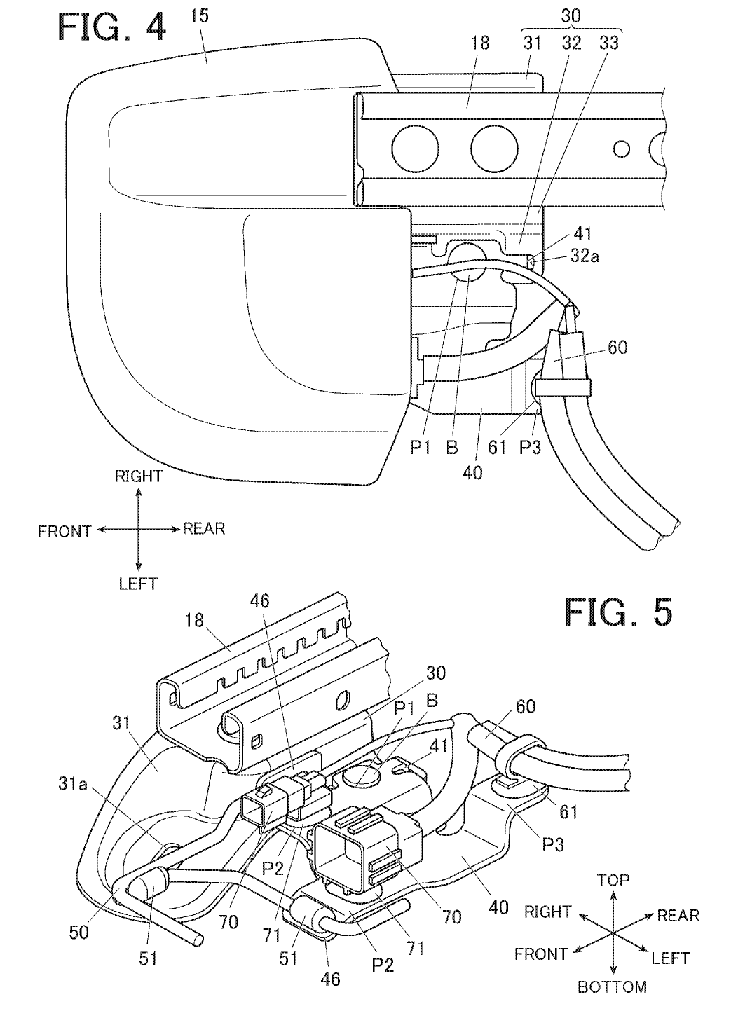

In a state in which the cover member 15 is latched to the latched member 50, the cover member 15 covers at least part of the fixing bracket 40, and the hook section 41 of the fixing bracket 40 is in a position not overlapping the cover member 15 from the top view (see FIGS. 3 and 4 ). In other words, the hook section 41 of the fixing bracket 40 and the cover member 15 are in positions where they do not interfere with each other.

The latched member 50 is, for example, a member consisting of two metal rod-shaped members welded together.

Here, two metal rods are joined by a welded section 51 which is a weld bead, and this forms the latched member 50 that presents a substantial Y-shape.

Such latched member 50 is fixed to the fixing end piece 46 of the fixing bracket 40 by the welded section 51 which is the weld bead.

The latched member 50, which consists of the metal rod-shaped member, is a member that is capable of elastic deformation to the extent that the rod-shaped member bends.

The harness 60 is a so-called wire harness or cable harness, which is a bundle of wires as the in-vehicle wires that are used for power supply and signal communication in the vehicle.

According to the vehicle seat S of the present embodiment, the harness 60 is fixed to the fixing bracket 40.

One end of such harness 60 is connected to the connector 70, and the electrical component 20 on the seat main body S3 side is connected to the other end.

The connector 70 is connected to the end of the harness 60 provided on the seat main body S3.

In the vehicle seat S according to the present embodiment, the relatively small connector 70 is located on the right side on the fixing bracket 40 and a relatively large connector 70 is located on the left side, and the two connectors 70 are fixed to the fixing bracket 40.

This connector 70 is a so-called female connector. A male connector connected to the end of the harness (not shown) is extended from the floor side of the vehicle, and is inserted into the connector 70 on the seat main body S3 side. As a result, the vehicle side is electrically connected to the electrical component 20 on the seat main body S3 side.

Next, the procedure for assembling and fixing the above parts (foot bracket 30, fixing bracket 40, latched member 50, harness 60, connector 70, and cover member 15) in the vehicle seat S according to the present embodiment and the manner in which they are fixed will be described.

The order in which the above parts are fixed does not have to be the order described below, and may be any order that is easy to assemble and rational to assemble and secure each part.

### Fixing the Foot Bracket and the Fixing Bracket

In a case in which the fixing bracket 40 is mounted and fixed to the foot bracket 30, first, the hook section 41 of the fixing bracket 40 is engaged in the hole section 32a of the foot bracket 30 and the fixing bracket 40 is placed on the flange section 32 of the foot bracket 30 so that the fixing bracket 40 is aligned with respect to the foot bracket 30.

At this time, the hook section 41 of the fixing bracket 40 is engaged in the hole section 32a of the foot bracket 30 and with this, the movement of the fixing bracket 40 with respect to the foot bracket 30 is restricted.

Next, the bolt hole 42 of the fixing bracket 40 is aligned with the bolt hole 32b of the foot bracket 30, the bolts B are inserted through the aligned bolt holes (42, 32b), these bolts B are screwed into the nuts N on a lower surface of the flange section 32, and the fixing bracket 40 is fixed to the foot bracket 30 (see FIG. 16).

At this time, since the hook section 41 of the fixing bracket 40 is engaged in the hole section 32a of the foot bracket 30, when the bolt B is screwed into the nut N, the movement of the fixing bracket 40 with respect to the foot bracket 30 is regulated so that the fixing bracket 40 does not go around together (rotate together).

Thus, when attaching and fixing the fixing bracket 40 to the foot bracket 30, by engaging the hook section 41 of the fixing bracket 40 in the hole section 32a of the foot bracket 30, the movement of the fixing bracket 40 with respect to the foot bracket is restricted, until the fixing bracket 40 is fixed to the foot bracket 30. Therefore, the fixing bracket 40 can be suitably fixed in the predetermined position on the foot bracket 30.

In particular, by employing the hook-shaped hook section 41 that can engage in the hole section 32a of the foot bracket 30 as the regulating section for regulating the movement of the fixing bracket 40 relative to the foot bracket 30, the positioning and the regulating of the movement of the fixing bracket 40 relative to the foot bracket 30 can be performed easily.

Since the movement of the fixing bracket 40 with respect to the foot bracket 30 is regulated by the cooperation between the hole section 32a of the foot bracket 30 and the hook section 41 of the fixing bracket 40, the hole section 32a of the foot bracket 30 (flange section 32) can also be considered to be the regulating section that regulates the movement of the fixing bracket 40 with respect to the foot bracket 30.

Here, it is assumed that the position where the fixing bracket 40 is fixed to the flange section 32 of the foot bracket 30 with the bolt B is a first fixing location P1 where the foot bracket 30 and the fixing bracket 40 are fixed.

The hole section 32a in the flange section 32 of the foot bracket 30 is provided in a position lower than the first fixing location P1 (see FIGS. 7 and 16 ).

The hole section 32a of the foot bracket 30 (flange section 32) is provided at a lower position than this first fixing location P1. This makes it easier to engage the hook section 41 in the hole section 32a of the flange section 32 and to place the fixing bracket 40 on the flange section 32 of the foot bracket 30. Consequently, it becomes possible to easily fix the fixing bracket 40 on the foot bracket 30.

The reinforcing section 33 is provided in a position near the flange section 32 of the foot bracket 30 and adjacent to the flange section 32. Therefore, such reinforcing section 33 increases the rigidity of the flange section 32.

Since the flange section 32 of the foot bracket 30 is provided with through holes such as the hole section 32a and the bolt hole 32b, there is concern that the strength of the flange section 32 may decrease. However, the rigidity of the flange section 32 is increased by the reinforcing section 33, and thus, the flange section 32 has sufficient strength.

Since the first fixing location P1 is located adjacent to the reinforcing section 33 and the rigidity of the flange section 32 is increased by the reinforcing section 33, the first fixing location P1 where the foot bracket 30 and the fixing bracket 40 are fixed has sufficient strength and a posture of the fixing bracket 40 fixed to the foot bracket 30 becomes stable.

### Fixing of the Latched Member to the Fixing Bracket

The latched member 50 is a member consisting of two metal rod-shaped members welded together and joined by the welded section 51, and presents the substantial Y-shape.

When fixing the latched member 50 to the fixing bracket 40, one end of the biforked portion is welded to the fixing end piece 46 on the left side of the fixing bracket 40, and the other end of the biforked portion is welded and fixed to the fixing end piece 46 on the right side of the fixing bracket 40.

Here, the ends of the biforked portion of the latched member 50 are each joined to the fixing end piece 46 by the welded section 51, and the latched member 50 is fixed to the fixing bracket 40 (see FIGS. 10-12 ).

Then, the latched member 50 fixed to the fixing bracket 40 is provided in an arrangement that sandwiches the first fixing location P1 in between with the hook section 41 of the fixing bracket 40 (See FIGS. 10-12 ).

Since the first fixing location P1 is located between the latched member 50 and the hook section 41, the latched member 50 and the hook section 41 are arranged apart and the hook section 41 is provided to the rear than the latched member 50, the latched member 50 does not interfere with the hook section 41. Therefore, the latched member 50 does not become a hinderance when the fixing bracket 40 is mounted to the foot bracket 30, and the fixing bracket 40 can be suitably mounted to the foot bracket 30.

The procedure for fixing the latched member 50 to the fixing bracket 40 is not limited to the above embodiment.

For example, one end of one of the two metal rod-shaped members may be welded to the left side fixing end piece 46 of the fixing bracket 40, and one end of the other metal rod-shaped member may be welded to the right side fixing end piece 46 of the fixing bracket 40, and then the other ends of the two metal rod-shaped members may be welded together to form the latched member 50. With this, the substantially Y-shaped latched member 50 may be fixed to the fixing bracket 40.

### Fixing of the Cover Member to the Latched Member

The cover member 15 is a resin member that covers at least part of the foot bracket 30 and the fixing bracket 40, for example, as shown in FIGS. 3 and 4 .

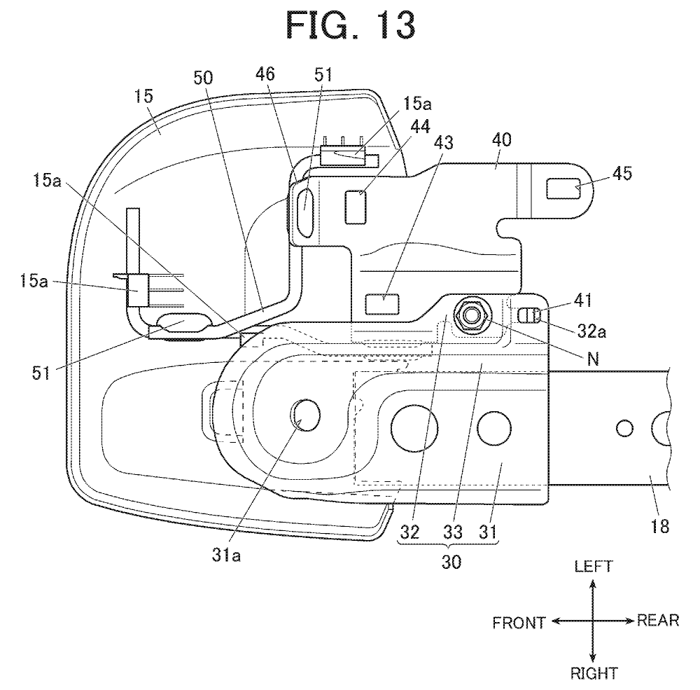

As shown in FIG. 13, for example, the rear surface of the cover member 15 is provided with a claw section 15a for latching the cover member 15 to the latched member 50.

The cover member 15 according to the present embodiment is provided with three claw sections 15a, and the cover member 15 is fixed to the latched member 50 in a manner in which the claw sections 15a are latched to three arm portions of the latched member 50, which has a substantial Y-shape.

In particular, the claw section 15a is provided on the cover member 15 so that the location where the claw section 15a of the cover member 15 latches to the latched member 50, which is the location where the cover member 15 latches to the latched member 50, is at a position where it does not overlap with the fixing bracket 40 in the vertical direction.

For example, when the cover member 15 is stepped on at the floor of a vehicle by the passenger and an external force acts on the cover member 15, the latched member 50 is elastically deformed to absorb and release the external force.

At this time, by setting the latching location of the cover member 15 and the latched member 50 in a position where the above does not overlap with the fixing bracket 40 in the vertical direction, it becomes difficult for the external force acting on the cover member 15 to be transmitted to the fixing bracket 40, and it is possible to prevent the load from being applied on the fixing bracket 40.

### Fixing the Harness and the Connector to the Fixing Bracket

When attaching and securing the harness 60 and the connector 70 to the fixing bracket 40, for example, as shown in FIGS. 5-12 , a clip 61 provided on the harness 60 and a clip 71 provided on the connector 70 are used to secure the harness 60 and the connector 70 to the mounting holes (43, 44, 45) in the fixing bracket 40.

When attaching and fixing the connector 70 to the fixing bracket 40, for example, as shown in FIGS. 5, and 8-10, , a projection of the clip 71 provided on the relatively small connector 70 is mounted and fixed by inserting into the mounting hole 43 of the fixing bracket 40, and the projection of the clip 71 provided on the relatively large connector 70 is mounted and fixed by inserting into the mounting hole 44 of the fixing bracket 40.

Here, the direction in which the connector 70 is mounted for fixing to the fixing bracket 40 is the same as the direction of engaging the hook section 41 of the fixing bracket 40 to the hole section 32a of the foot bracket 30.

If the direction in which the connector 70 is mounted for fixing to the fixing bracket 40 and the direction in which the hook section 41 is engaged in the hole section 32a are the same orientation, the orientation in which each part is mounted to the foot bracket 30 can be aligned, making it easier to mount and fix each part.

The clip 71 provided on the connector 70 may be the clip 71 integrally molded into the connector 70 or the separate clip 71 added on to the connector 70.

It is assumed that the position where the connector 70 is fixed to the fixing bracket 40 is a second fixing location P2 where the fixing bracket 40 and the connector 70 are fixed.

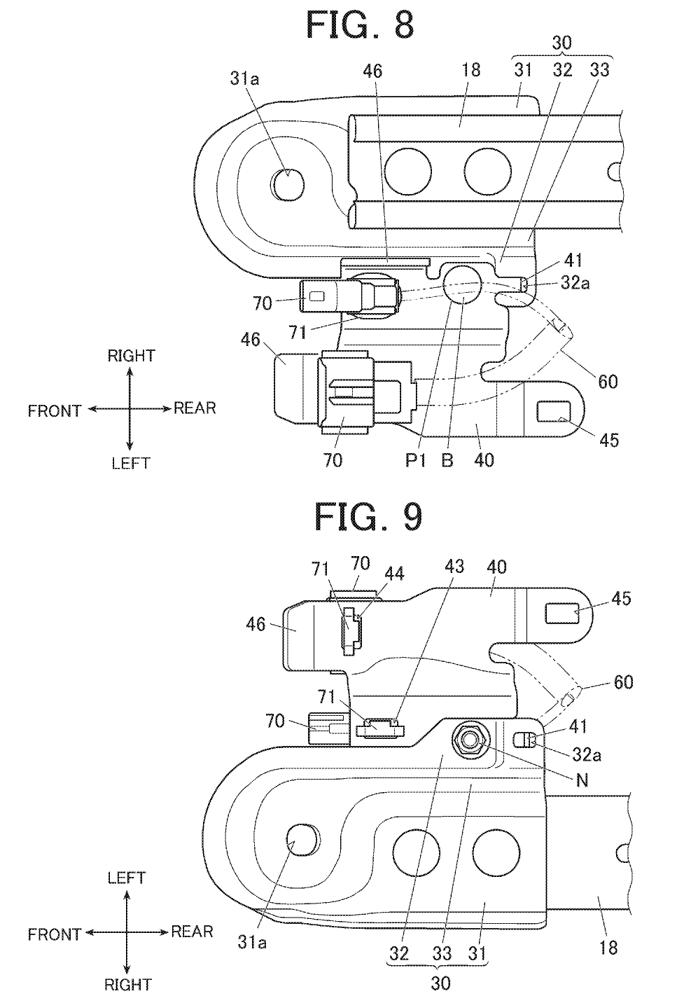

The hook section 41 of the fixing bracket 40 is provided at a position closer to the harness 60 and to the rear than the second fixing location P2 where the connector 70 and the fixing bracket 40 are fixed (see FIGS. 5 and 8).

Since the hook section 41 is to the rear than the second fixing location P2, the connector 70 and the hook section 41 do not interfere with each other.

Moreover, since the hook section 41 and the harness 60 are located to the rear than the second fixing location P2, the male connector (not shown) on the floor side of the vehicle can be easily inserted to the connector 70 of the second fixing location.

When the harness 60 is mounted and fixed to the fixing bracket 40, for example, as shown in FIGS. 5,10 and 7, the projection of the clip 61 arranged on the harness 60 is mounted and fixed by inserting into the mounting hole 45 of the fixing bracket 40.

Here, the direction in which the harness 60 is mounted for fixing to the fixing bracket 40 is the same as the direction that the hook section 41 of the fixing bracket 40 is engaged to the hole section 32a of the foot bracket 30.

If the direction in which the harness 60 is mounted for fixing to the fixing bracket 40 and the direction in which the hook section 41 is engaged in the hole section 32a are the same orientation, the orientation in which each part is mounted to the foot bracket 30 can be aligned, making it easier to mount and fix each part.

In addition, it is assumed that the position in which the harness 60 is fixed to the fixing bracket 40 is a third fixing location P3 where the fixing bracket 40 and the harness 60 are fixed.

At this time, the hook section 41 of the fixing bracket 40 is in a position lower than the third fixing location P3 where the harness 60 and the fixing bracket 40 are fixed (see FIG. 7).

This hook section 41 is located in a position lower than the third fixing location P3, and thus, the harness 60 does not interfere with the hook section 41.

The hook section 41 is located in a position lower than the third fixing location P3, and thus it is easier to engage the hook section 41 into the hole section 32a and to fix the fixing bracket 40 to the foot bracket 30.

The foot bracket 30, for example, as shown in FIG. 9, includes a shape that has no overlapping portions with the position where the harness 60 and the connector 70 (here, in particular, the relatively small connector 70) are fixed to the fixing bracket 40.

Specifically, the flange section 32 of the foot bracket 30, is to have a size including the portion where the hole section 32a is provided for engaging the hook section 41, and the portion where the bolt B is screwed into the nut N, and includes a bracketed shape to avoid the position (mounting hole 43) where the relatively small connector 70 is fixed to the fixing bracket 40.

The foot bracket 30 is formed in such bracketed shape, and thus, when the harness 60 or the connector 70 is fixed to the fixing bracket 40, even if the projection of the clips (61, 71) of the harness 60 and the connector 70 protrude from the lower surface side of the fixing bracket 40, since these clips (61, 71) do not interfere with the foot bracket 30, the fixing bracket 40 can be securely fixed to the foot bracket 30.

Next, a procedure for fixing the fixing bracket 40, the latched member 50, the harness 60, and the connector 70 to the foot bracket 30 is described.

The example described here is a case in which the latched member 50 is already fixed to the fixing bracket 40, and the fixing bracket 40 and the latched member 50 are handled and fixed as one unit.

### First Procedure

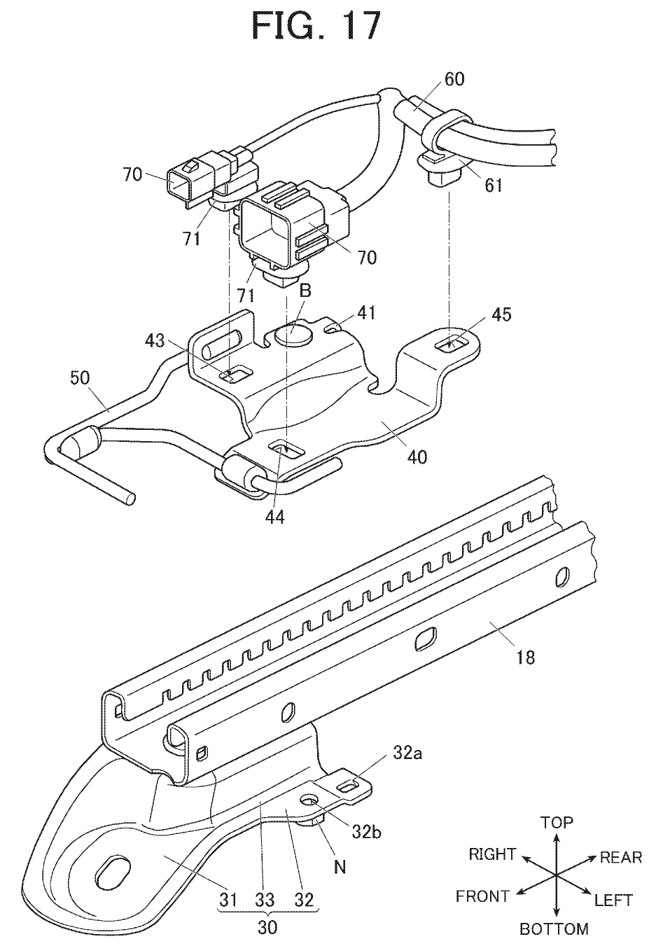

In the first procedure, the harness 60 and the connector 70 are fixed to the fixing bracket 40, as shown in FIG. 17.

Specifically, the clip 71 of the relatively small connector 70 is mounted and fixed to the mounting hole 43 of the fixing bracket 40, and the clip 71 of the relatively large connector 70 is mounted and fixed to the mounting hole 44 of the fixing bracket 40. The clip 61 provided on the harness 60 is mounted and fixed to the mounting hole 45 of the fixing bracket 40.

The order in which the harness 60 and the connector 70 are fixed to the fixing bracket 40 may be any order, and the harness 60 and the connector 70 should be fixed in the order which is easy for the operator to fix.

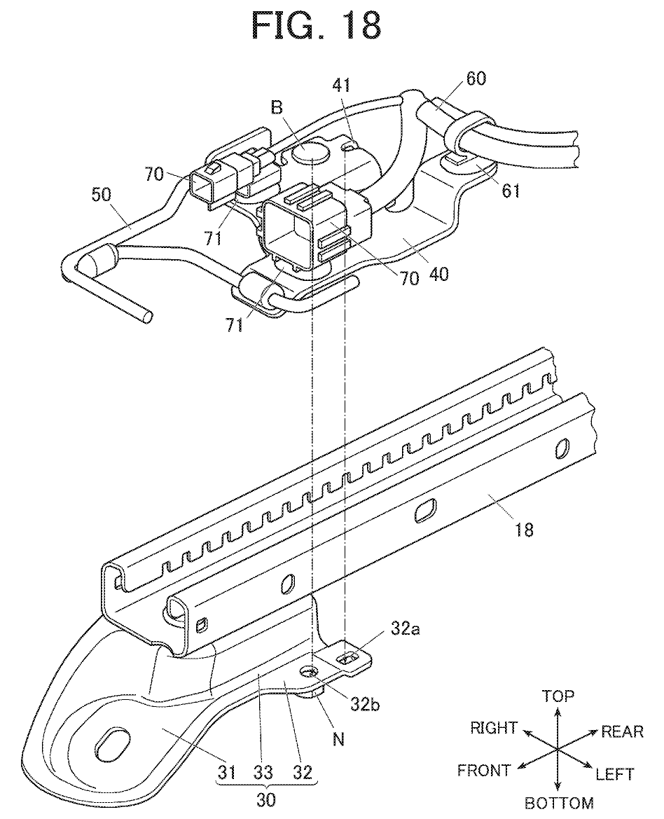

Next, as shown in FIG. 18, the fixing bracket 40, to which the harness 60 and connector 70 are fixed, is fixed to the foot bracket 30.

As described above, after engaging and aligning the hook section 41 of the fixing bracket 40 with the hole section 32a of the foot bracket 30, the bolt B is screwed into the nut N to fix the fixing bracket 40 to the foot bracket 30. In this way, until the fixing bracket 40 is fixed to the foot bracket 30, since the movement of the fixing bracket 40 is regulated relative to the foot bracket 30, the fixing bracket 40 can be suitably fixed in a predetermined position on the foot bracket 30.

In this way, as shown in FIG. 5, the fixing bracket 40 can be fixed to the foot bracket 30.

According to such first procedure, the direction in which the harness 60 and the connector 70 are mounted for fixing to the fixing bracket 40 and the direction in which the hook section 41 is engaged in the hole section 32a are the same orientation. Therefore, it is easy to perform the process of fixing the harness 60, the connector 70, and the fixing bracket 40 to the foot bracket 30 and each part can be suitably fixed.

In particular, according to the first procedure, it is possible to fix the harness 60 and the connector 70 collectively together with the fixing bracket 40 to the foot bracket 30.

In this way, the fixing operation can be performed in a more simple manner than performing the operation of fixing the harness 60 and the connector 70 individually in the narrow region around the foot bracket 30.

### Second Procedure

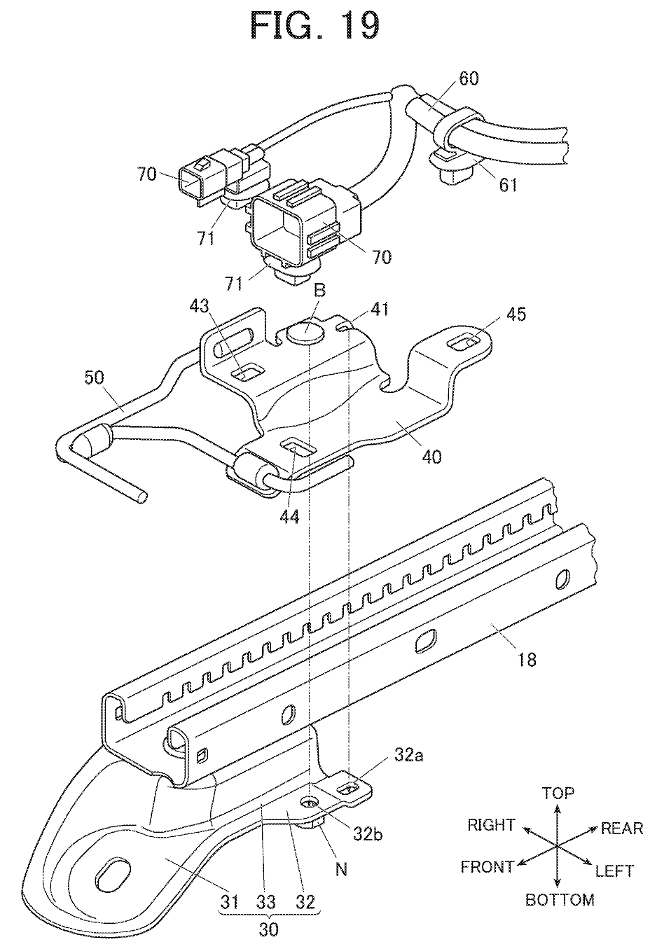

In the second procedure, first, the fixing bracket 40 is fixed to the foot bracket 30, as shown in FIG. 19.

As described above, after engaging and aligning the hook section 41 of the fixing bracket 40 with the hole section 32a of the foot bracket 30, the bolt B is screwed into the nut N to fix the fixing bracket 40 to the foot bracket 30. In this way, until the fixing bracket 40 is fixed to the foot bracket 30, since the movement of the fixing bracket 40 is regulated relative to the foot bracket 30, the fixing bracket 40 can be suitably fixed in a predetermined position on the foot bracket 30.

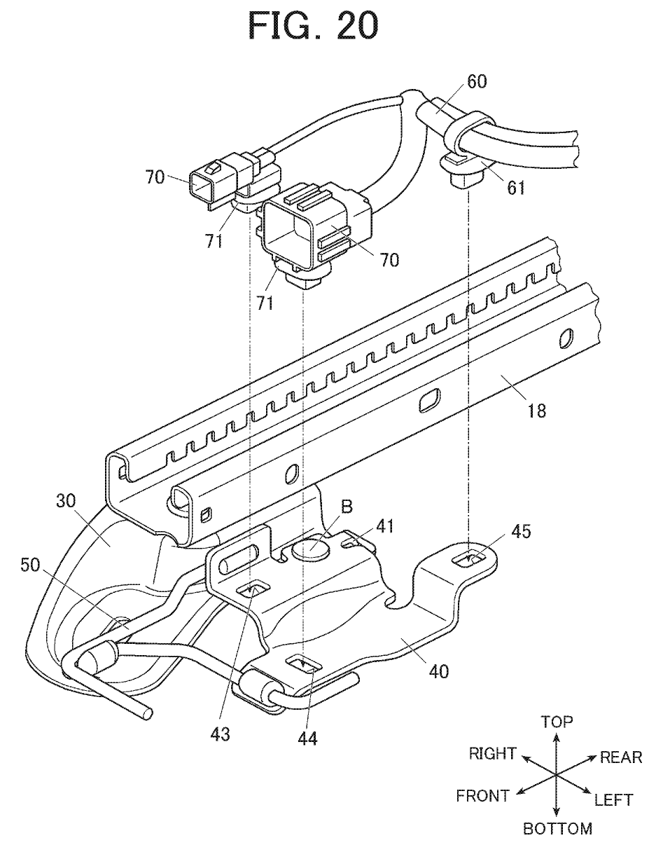

Next, as shown in FIG. 20, the harness 60 and the connector 70 are fixed to the fixing bracket 40, which is fixed to the foot bracket 30.

Specifically, the clip 71 of the relatively small connector 70 is mounted and fixed to the mounting hole 43 of the fixing bracket 40, and the clip 71 of the relatively large connector 70 is mounted and fixed to the mounting hole 44 of the fixing bracket 40. The clip 61 provided on the harness 60 is mounted and fixed to the mounting hole 45 of the fixing bracket 40.

The order in which the harness 60 and the connector 70 are fixed to the fixing bracket 40 may be any order, and the harness 60 and the connector 70 should be fixed in the order which is easy for the operator to fix.

In this way, as shown in FIG. 5, the fixing bracket 40 can be fixed to the foot bracket 30.

According to such second procedure, the direction in which the hook section 41 is engaged in the hole section 32a and the direction in which the harness 60 and the connector 70 are mounted for fixing to the fixing bracket 40 are the same orientation. Therefore, it is easy to perform the process of fixing the fixing bracket 40, the harness 60, and the connector 70 to the foot bracket 30 and each part can be suitably fixed.

In particular, according to the second procedure, it is possible to handle the fixing bracket 40, the harness 60, and the connector 70 separately and to fix each of the above.

In this way, a finely maneuverable fixing operation can be performed in the narrow region around the foot bracket 30, compared to a case in which the harness 60 and the connector 70 fixed to the fixing bracket 40 are handled together (first procedure).

As described above, the vehicle seat S according to the present embodiment includes a configuration that facilitates fixing the fixing bracket 40, the harness 60, and the connector 70 to the foot bracket 30 that fixes the slide rail 19 (lower rail 18) supporting the seat main body S3 to the vehicle body floor (not shown). With this, it is possible to suitably fix the fixing bracket 40, the harness 60, and the connector 70 to the foot bracket 30.

According to the above embodiments, the hook section 41 that is engaged in the hole section 32a of the foot bracket 30 is described as the regulating section that regulates the movement of the fixing bracket 40 with respect to the foot bracket 30 until the fixing bracket 40 is mounted and fixed to the foot bracket 30. However, the regulating section of the present disclosure is not limited to this, and for example, a regulating section using a concave-convex fit or a regulating section using a magnet may be employed.

According to the above embodiments, the harness 60 and connector 70 are described as examples of the predetermined members fixed to the fixing bracket 40. However, the present disclosure is not limited to the above, and as the predetermined member fixed to the fixing bracket 40, a sensor that senses a load of a person seated on the vehicle seat S may be employed.

According to the above embodiment, the reinforcing section 33 for reinforcing the flange section 32 is a bent portion formed by beading in the press work, but the present disclosure is not limited to this. For example, the reinforcing section 33 may be provided with a thick-walled portion between the bracket main body section 31 and the flange section 32.

Such thick-walled portion may be solidified with the additional sheet metal or may be formed to be a weld bead.

According to the above embodiment, as the latched member 50 to which the cover member 15 is latched, two metal rod-shaped members welded together are described as an example. However, the present disclosure is not limited to the above, and for example, a metal wire or thin plate material may be used, or a plastic rod-shaped member, wire material, or thin plate material may be used as long as the latched member 50 has elasticity to be able to deform in a bending manner.

In addition, it is of course possible to change other specific details of the structure as needed.

According to an aspect of the present disclosure, a vehicle seat includes: a first fixer that is configured to fix a slide rail that supports a seat main body to a vehicle body floor; and a second fixer that is mounted to the first fixer and that is configured to fix a predetermined member provided on the seat main body, wherein the second fixer is provided with a regulator that regulates a movement of the second fixer relative to the first fixer until the second fixer is mounted and fixed to the first fixer.

According to the above embodiment, when the second fixing member is mounted and fixed to the first fixing member, the movement of the second fixing member relative to the first fixing member is regulated by the regulating section of the second fixing member until the second fixing member is fixed to the first fixing member. Therefore, it is possible to suitably fix the second fixing member to the predetermined position of the first fixing member.

According to the vehicle seat described above, the regulator is a hook that is engaged in a hole provided in the first fixer.

According to the above embodiment, by engaging the hook section of the second fixing member in the hole section of the first fixing member, since the movement of the second fixing member relative to the first fixing member is regulated until the second fixing member is fixed to the first fixing member, the second fixing member can be suitably fixed to the predetermined position of the first fixing member.

In particular, by employing a hook-shaped hook section that can engage in the hole section of the first fixing member as the regulating section that regulates the movement of the second fixing member relative to the first fixing member, positioning and movement regulation of the second fixing member relative to the first fixing member can be easily performed.

According to the vehicle seat described above, the hole is provided in a position lower than a first fixing location in which the first fixer and the second fixer are fixed.

According to the above embodiment, the hole section of the first fixing member is provided at a lower position than the first fixing location where the first fixing member and the second fixing member are fixed. This makes it easier to engage the hook section of the second fixing member in the hole section of the first fixing member. Therefore, the second fixing member can be easily fixed to the first fixing member.

According to the vehicle seat described above, a reinforcer is provided near the hole in the first fixer, and the first fixing location is in a position adjacent to the reinforcer.

According to the above embodiment, since the first fixing location is located in a position adjacent to the reinforcing section and the rigidity in the vicinity of the first fixing location is increased by the reinforcing section. With this, the first fixing location where the first fixing member and the second fixing member are fixed has sufficient strength. Consequently, the posture of the second fixing member fixed to the first fixing member becomes stable.

According to the vehicle seat described above, a direction in which the predetermined member is mounted for fixing to the second fixer is the same as the direction in which the hook is engaged in the hole.

According to the above embodiment, when the direction in which the predetermined member is mounted for fixing to the second fixing member and the direction in which the hook section is engaged in the hole section are the same orientation, the orientation in which the second fixing member is mounted to the first fixing member, and the orientation in which the predetermined member is mounted to the second fixing member can be aligned. Consequently, it becomes easier to mount and fix the members.

According to the vehicle seat described above, the predetermined member includes a connector that is connected to an end of a harness provided in the seat main body, and the hook is in a position that is to the rear than a second fixing location in which the connector and the second fixer are fixed and that is closer to the harness.

According to the above embodiment, by providing the hook section in a position closer to the harness at the rear than the second fixing location where the connector which is the predetermined member and the second fixing member are fixed, the connector and the hook section do not interfere with each other.

Moreover, the hook section and the harness are located to the rear than the second fixing location. Consequently, it becomes easier to insert the connector on the vehicle floor side to the connector on the vehicle seat side at the second fixing location.

According to the vehicle seat described above, the first fixer includes a shape with no portion that overlaps with a position in which the predetermined member is fixed to the second fixer.

According to the above embodiment, the shape of the first fixing member is such that there is no portion that overlaps with the position where the predetermined member is fixed to the second fixing member. Therefore, even if a part of the predetermined member sticks out from the second fixing member when the predetermined member is fixed to the second fixing member, the sticking out portion does not interfere with the first fixing member. Consequently, the second fixing member can be securely fixed to the first fixing member.

According to the vehicle seat described above, the predetermined member includes a harness that is provided in the seat main body, and the hook is in a position lower than a third fixing location in which the harness and the second fixer are fixed.

According to the above embodiment, the hook section is located in a position lower than the third fixing location where the harness which is the predetermined member and the second fixing member are fixed. Consequently, the harness and the hook section do not interfere with each other.

The hook section is located in a position lower than the third fixing location. With this, it is easier to engage the hook section in the hole section and to fix the second fixing member to the first fixing member.

According to the vehicle seat described above, the vehicle seat further includes a cover that covers at least a part of the first fixer and the second fixer; and a latched member that is fixed to the second fixer and to which the cover member is latched, wherein the latched member is provided in an arrangement that sandwiches the first fixing location between the latched member and the hook.

According to the above embodiment, since the first fixing location is located between the latched member and the hook section, the latched member and the hook section are arranged apart. With this, the latched member and the hook section do not interfere with each other. Therefore, the latched member does not become an obstacle when the second fixing member is mounted to the first fixing member. Consequently, the second fixing member can be suitably attached to the first fixing member.

According to the vehicle seat described above, a latching location between the cover and the latched member is in a position that does not overlap with the second fixer in a vertical direction.

According to the above embodiment, by providing the latching location of the cover member and the latched member in a position where they do not overlap with the second fixing member in a vertical direction, the external force acting on the cover member is not easily transmitted to the second fixing member, making it difficult for the load to be applied on the second fixing member.

Although some embodiments of the present disclosure have been described and illustrated in detail, the disclosed embodiments are made for purposes of not limitation but illustration and example only. The scope of the present disclosure should be interpreted by terms of the appended claims.

1. A vehicle seat comprising:
a first fixer that is configured to fix a slide rail that supports a seat main body to a vehicle body floor; and
a second fixer that is mounted to the first fixer and that is configured to fix a predetermined member provided on the seat main body,
wherein the second fixer is provided with a regulator that regulates a movement of the second fixer relative to the first fixer until the second fixer is mounted and fixed to the first fixer.

2. The vehicle seat according to claim 1, wherein the regulator is a hook that is engaged in a hole provided in the first fixer.

3. The vehicle seat according to claim 2, wherein the hole is provided in a position lower than a first fixing location in which the first fixer and the second fixer are fixed.

4. The vehicle seat according to claim 3, wherein,
a reinforcer is provided near the hole in the first fixer, and
the first fixing location is in a position adjacent to the reinforcer.

5. The vehicle seat according to claim 2, wherein a direction in which the predetermined member is mounted for fixing to the second fixer is the same as the direction in which the hook is engaged in the hole.

6. The vehicle seat according to claim 5, wherein,
the predetermined member includes a connector that is connected to an end of a harness provided in the seat main body, and
the hook is in a position that is to the rear than a second fixing location in which the connector and the second fixer are fixed and that is closer to the harness.

7. The vehicle seat according to claim 1, wherein the first fixer includes a shape with no portion that overlaps with a position in which the predetermined member is fixed to the second fixer.

8. The vehicle seat according to claim 2, wherein,
the predetermined member includes a harness that is provided in the seat main body, and
the hook is in a position lower than a third fixing location in which the harness and the second fixer are fixed.

9. The vehicle seat according to claim 3, further comprising:
a cover that covers at least a part of the first fixer and the second fixer; and
a latched member that is fixed to the second fixer and to which the cover member is latched,
wherein the latched member is provided in an arrangement that sandwiches the first fixing location between the latched member and the hook.

10. The vehicle seat according to claim 9, wherein a latching location between the cover and the latched member is in a position that does not overlap with the second fixer in a vertical direction.
